(19) United States
(12) Patent Application Publication
(10) Pub. No.: US 2009/0264544 A1
(43) Pub. Date: Oct. 22, 2009

(54) Polyarylene polymers and ion conducting functionalized polyarylene polymers resulting from pairing bis-diene arylenes and bis-dienophile arylenes via a diels-alder reaction

(75) Inventor: Dougles Anson Loy, Tucson, AZ (US)

Correspondence Address: Alberto A. Leon, Esq., PO Box 30684, Albuquerque, NM, 87190, US

(73) Assignee: Energy Materials Corporation

(21) Appl. No.: 12/148,341

(22) Filed: Apr. 17, 2008

(51) Int. Cl. C08J 5/20; B01J 49/00

(52) U.S. Cl. 521/27

(57) ABSTRACT

The invention discloses a group of novel and functionalized arylene polymers that comprise repeat units from a group consisting of polyarylene, polybenzimidazolene, polybenzimidazole, and poly(arylene-co-cyclohexadiene). The compositions are created via Diels-Alder polymerization and result in a polymer that is chemically and thermally stable. The polyarylene polymers can be used to create improved polymer electrolyte membranes that overcome the limitations of Nafion® membranes for use in fuel cells.

### BACKGROUND OF THE INVENTION

1. Technical Field of the Invention

The present invention relates generally to novel arylene polymers and to functionalized arylene polymers. More specifically the present invention relates to chemically and thermally stable polyarylene polymers and ion conduction functionalized polyarylene polymers which result from pairing bis-diene arylenes and bis-dienophile arylenes via a Diels-Alder reaction.

2. Description of the Background Art

Oxidatively stable polymers and/or ion conductive polymers have great potential and usefulness. Those polymers can be used in a variety of commercial applications, including, most notably, polymer electrolyte membrane fuel cells (PEMFCs). Those polymers also find use as oxidatively resistant materials for electrochemical cells, fuel cells, electrolysis cells, oxygen barrier materials, sealants and adhesives for photovoltaics and organic light emitting diodes (OLED).

Fuel cells are generally considered a highly efficient and environmentally friendly energy source. Notably, PEMFCs have a high power density and a low weight to power ratio. Ion conducting polymer membranes, which function as electrolytes, are a key element of PEMFCs.

Fuel cells are electrochemical cells in which a free energy change resulting from a fuel oxidation reaction is converted into electrical energy. Fuel cells are attractive electrical power sources due to their higher energy efficiency and environmental friendliness when compared with energy sources derived from, for example, internal combustion engines. The best known fuel cells use a gaseous fuel (such as hydrogen) with a gaseous oxidant (usually pure oxygen or atmospheric oxygen). Fuel cells using direct feed organic fuels such as methanol are also well known.

The polymer electrolyte membrane or proton exchange membrane (PEM) is a crucial component of any PEMFC. The PEMs are an excellent conductor of hydrogen ions (protons). To date, the most widely used membrane materials for PEMFCs comprise a fluorocarbon polymer backbone, similar to Teflon®, with attached sulfonic acid groups. The pendant acid groups of these Teflon® type materials are fixed to the polymer backbone and cannot “leak” out, but the protons (via the pendant sulfonic groups) on these acid groups are free to migrate through the polymeric membrane material. These Teflon® type materials owe their electrochemical stability to the presence of fluorine substituents attached to the carbon atoms of their polymeric backbone. The strong fluorine carbon bonds make these polymers relatively impervious to the degradations suffered by most familiar polymers or plastics. The same inertness makes Teflon® like materials resistant to oxidation and suitable as a non-stick coating for cookware. With the solid polymer electrolyte, electrolyte loss is not a problem affecting stack life. The potential power generated by a fuel cell stack depends on the number and size of the individual fuel cells that comprise the stack and the surface area of the PEM.

In many fuel cells, the anode and/or cathode comprise a layer of electrically conductive, catalytically active particles (usually in a polymeric binder). A polymer electrolyte membrane is sandwiched between an anode and cathode, and the three components are sealed together to produce a single membrane electrode assembly (MEA). The anode and cathode are prepared by applying a small amount of a catalyst, for example platinum (Pt) or ruthenium-platinum (Ru/Pt), in a polymeric binder to a surface that will be contacted with the PEM.

Preparation of catalyst electrodes has traditionally been achieved by using an ink consisting of an electro catalyst (either Pt or Ru/Pt) and Nafion® polymer (5% wt. solution dispersed in a lower alcohol). The ink is then applied to porous carbon paper using a painting technique, by direct deposition on the polyelectrolyte polymeric membrane surface or pressing it upon the polymeric membranes like a decal. A MEA of a hydrogen fuel cell accepts hydrogen from a fuel gas stream that is consumed at the anode, yielding electrons (via an external circuit) to the cathode and produces hydrogen ions which enter the (PEM) electrolyte. The polymer electrolyte membrane allows only the hydrogen ions to pass through it to the cathode, while the co-produced electrons must travel along an external circuit to the cathode, thereby creating an electrical current. At the cathode, oxygen combines with electrons delivered by the external circuit to the cathode and hydrogen ions that migrate through the electrolyte to produce water. The water does not dissolve the electrolyte and is, instead, rejected from the back of the cathode. A polymer electrolyte membrane should be impermeable to air or hydrogen (or methanol for a Direct Methanol Fuel Cell), tolerant of low humidity or water, and highly permeable to protons. The electrode modifier, on the other hand, should be highly proton conducting and highly permeable to air and fuel. Otherwise, the result is reduced fuel cell efficiency due to parasitic losses and fuel cell failure from desiccation or flooding.

Over the last 30 years the industry standard for the PEM component of a hydrogen or methanol fuel cell has been membranes based on fluorine-containing polymers. A salient example is the Nafion® material as marketed by DuPont. The Nafion® material is often used as membrane material for fuel cells and operates at temperatures close to ambient. Further, Nafion® polymer membranes are hydrated, and they have a hydrogen ion conductivity of about 10⁻²S/cm or higher.

Nafion® membranes display adequate proton conductivity, chemical resistance, and mechanical strength at ambient temperature. However, some of the Nafion® membranes disadvantages are: reduced conductivity at high temperatures (>80° C.), high methanol permeability in direct methanol fuel cells, relatively thick membranes, and membrane dehydration. Further, Nafion® membranes thermally deform when they are used in PEMFCs at temperatures above 80° C. That deformation of the membrane prevents the Nafion® membrane from coming into sufficient contact with the electrodes, thereby reducing fuel cell performance. Additionally, Nafion® membranes' desirability is reduced by their relatively high cost. Nafion® membranes' usefulness in methanol fuel cells is limited. Nafion® membranes are permeable to methanol. Methanol crossover is inversely proportional to the Nafion® membrane thickness. Direct transport of the fuel (i.e. methanol) across the Nafion® membrane to the cathode results in efficiency loss. Increasing thickness of the Nafion® membrane results in decreased methanol crossover. However, thicker membranes result in Ohmic losses and decreased fuel cell performance.

Compared to Nafion® type membranes, membranes that decrease the rate of methanol crossover would allow the use of higher concentrations of methanol-water feed mixtures. That would increase catalyst efficiency, direct methanol fuel cell power out put, and, potentially, fuel utilization.

Increasing the operation temperature of fuel cells is generally advantageous for several reasons. Higher operating temperatures in methanol fuel cells decrease the carbon monoxide poisoning of the electrocatalyst. Higher temperatures increase reaction kinetics of hydrogen oxidation on the anode and oxygen reduction on the cathode. However, in the case of Nafion® type membranes, as temperatures increase, it is more difficult to keep the membrane hydrated. Dehydration of such a membrane is exacerbated by its relative thickness. A dehydrated membrane loses ionic conductivity and results in poor contact between fuel cell components due to shrinkage of the membrane.

Improved performance of fuel cells could be achieved by reducing the membrane thickness and improving the humidification state of solid PEMs. Water molecules can promote proton transport, and a thin membrane can reduce ionic resistance and Ohmic losses.

Contact between the membrane and electrode affects the efficiency of a fuel cell. Interfacial resistance between the membrane and electrode causes Ohmic loss, thereby decreasing fuel cell efficiency.

Improving the membrane-electrode contact and continuity wherein the membrane and electrode are cast from a composition having a closely similar chemical structure to that of the polymer electrolyte improves the membrane-electrode interfacial resistance. A composition to make improved polymer electrolyte membranes, electrodes and electrode casting solutions is needed. Such composition would also have to display improved performance at temperatures at about 80° C. and above. Operating at these temperatures results in enhanced diffusion rates and reaction kinetics for methanol oxidation, oxygen reduction, and CO desorption, thereby producing a more efficient fuel cell.

The antioxidant polymers of this invention are oxidatively resistant materials useful for electrochemical cells, fuel cells, electrolysis cells, oxygen barrier materials, paints, coatings, displays, food and beverage containers, pharmaceutical packaging, and sealants and adhesives for photovoltaics and OLED's, among other applications. The sulfonated polyarylenes of the present invention are also useful as battery separators, electrolytes for electrosynthesis cells, electrolytes for electrolysis cells, electrolytes for gas generating electrochemical systems, as ionic membranes in electrochemical sensors, as electrolytes in electrochemical scrubbers and other purification systems and as electrolytes in primary and secondary batteries.

### SUMMARY OF THE INVENTION

The present application discloses and claims improved compositions, resistant to oxidation, as well as improved polymer electrolyte membranes formed therefrom for use in fuel cells, high performance capacitors, and dialysis equipment. The membranes made from the improved compositions of this invention overcome the limitations of Nafion® membranes set forth in the background of the invention section above. Generally the improved polymers of this invention are characterized by their polymeric repeating unit within the resulting polymer backbone, that repeating unit being selected from the group consisting of one of the following structures:
A) Polyarylene Diels-Alder adduct of bis(alkynyl)arene dienophiles with one of the following diene monomers:
bis(tetraphenylcyclopentadienone)arenes, 3,6-tetrazines and
bis(thiophenendioxide)arenes having polymer repeat units of the following general structures:

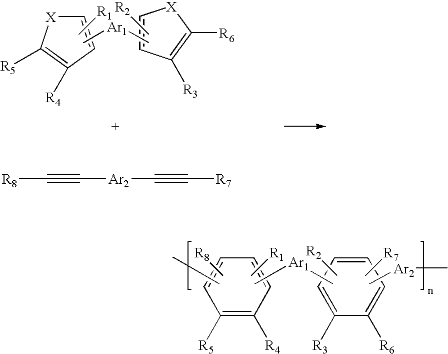

wherein the backbone comprises repeat units with Arene groups, Ar₁ and Ar₂, from the monomers, and aromatic rings with substituents R₁-R₈ derived from the cycloaddition reaction. The structure can have a combination of regiochemistries (meta and para) characteristic of Diels-Alder reactions as indicated by the ambiguous placement of the bonds from the aromatic rings to Ar₁ in the figure above. The pendant aryl groups R₁-R₈ can bear the sulfonic acid groups or precursors to sulfonic acid groups, such as trialkylsilylgroups, that make the polymers ion conducting.
B) Novel polybenzimidazoles. Polyarylene Diels-Alder adduct of bis-imidazole monomers with one of the following diene monomers: bis(tetraphenylcyclopentadienone)arenes, 3,6-tetrazines and bis(thiophenendioxide)arenes; having polymer repeat units of the following structures:

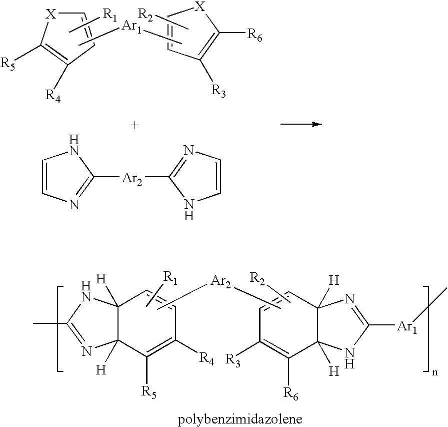

The benzimidazolene is the initial product of the Diels-Alder polymerization that can act as an anti-oxidant, after it loses its hydrogens, it becomes the more stable benzimidazole.
C) Polyarylenes with one or two cyclohexadiene groups in the backbone of each monomer repeat unit are the Diels-Alder adduct of bis(alkenvl)arene dienophiles with one of the following diene monomers: bis(tetraphenylcyclopentadienone)arenes, 3,6-tetrazines and bis(thiophenendioxide)arenes: having polymer repeat units of the following structures:

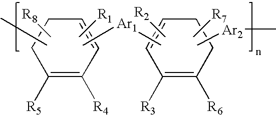

Loss of the four hydrogens per repeat unit to radicals or oxidants will convert this polymer to a stable fully aromatic polyarylene (A).

The phenylated polyarylenes used in this invention are built on a polyarylene backbone, benzene rings linked or fused together to form a chain of those repeating units. Multiple phenyl groups are attached to the backbone. The phenyl groups' function is primarily to prevent the polymer from crystallizing into an intractable, inert solid. Those phenyl groups prevent the polyarylenes from organizing into compact, crystalline arrays that would render them impossible to process. Thus, the phenylated polyarylene is soluble in organic solvents, but insoluble in water, just like polystyrene in its propensities to dissolve. It is important to note, however, that the resemblance is somewhat misleading. Polystyrene depolymerizes above 340° C. and is highly susceptible to oxidation and degradation. The polyarylenes of the present invention, on the other hand, are stable to above 500° C., and do not require fluorine groups for oxidative stability, providing a major reduction in cost.

The synthetic approach disclosed and claimed in the present application permits precise control over the number and positioning of acidic or basic groups on the polymer chain. That is not possible through simple sulfonation of a polyarylene. That control is central to the resulting polyarylenes' improved ionic conductivity, thermal stability, and permeability. Likewise,,the synthetic approach disclosed and claimed in this application permits the production of antioxidatively stable polyarylene polymers (see item C, above).

Many benzimidazoles accessible through this invention are prohibitively expensive when prepared using classical condensation approaches or cannot be prepared because the monomers are not readily available. For example, the simplest and only commercially available polybenzimidazole is prepared from the condensation of meta-phthalic acid and 3,3′,4,4′-tetraminobiphenyl, which costs $4444 per kilogram (Fuel Cell Bulletin, 2004, 5, 10).

The polyarylenes of this invention are prepared by an unusual approach; a Diels-Alder polymerization reaction. Most polymers are prepared by condensation chemistry or a chain reaction based on a strong base, acid, or radical initiator. In contrast, the Diels-Alder reaction requires two components: a bis-diene (such as a biscyclopentadienone or a tetrazine monomer) and a bis-dienophile. These diene and dienophile monomers react for form a new six-member ring festooned with one, two or three double bonds that links the two monomers together. In its simplest form, the Diels-Alder reaction is reversible. However, that is not the case in the case of the polyarylenes of the present invention, as will be seen below.

The Diels-Alder preparation of polyarylenes typically (though not always) requires two monomers: one with two diene groups and the other with two dienophilic groups. A diene moiety on one monomer reacts with the dienophile moiety on a second monomer to generate a dimer that has a diene moiety on one end and a dienophile moiety of the other end. These two Diels-Alder reactive groups on the terminal ends of the dimer, in turn, react with more monomers and, eventually, macromolecules with molecular weights rivaling proteins are obtained.

In addition to providing a robust platform for polymer electrolytes, Diels-Alder polymerizations using bis-alkenyl dienophile co-monomers with bis-cyclopentadienone or tetrazine monomers allow the construction of polymers containing high loadings of 1,3-cyclohexadiene groups that can serve as anti-oxidants or radical scavengers, as illustrated below:

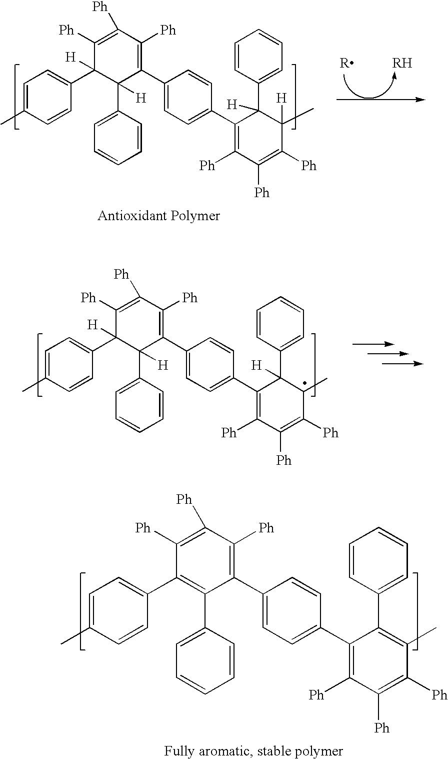

Molecules bearing cyclohexadiene have been shown to have excellent antioxidant properties based on the strong tendency of the cyclohexadienes to lose two ring bound hydrogens and become fully aromatic rings (J. Agric. Food Chem. 2003, 51, 2758-2765);

Radicals generated by aging processes or oxygen itself abstract hydrogen atoms, thereby ending radical chain reactions that would otherwise degrade the polymer. The basic concept for preparing the new polymers disclosed and claimed herein is the same used for preparing the polyarylene for fuel cell membranes, except that bis-alkene dienophiles are used instead of bis-akynes. A result of that variation is that the bis-alkene dienophiles are less reactive and Lewis acid catalysts and/or high pressure (>1 kbar) are needed to polymerize.

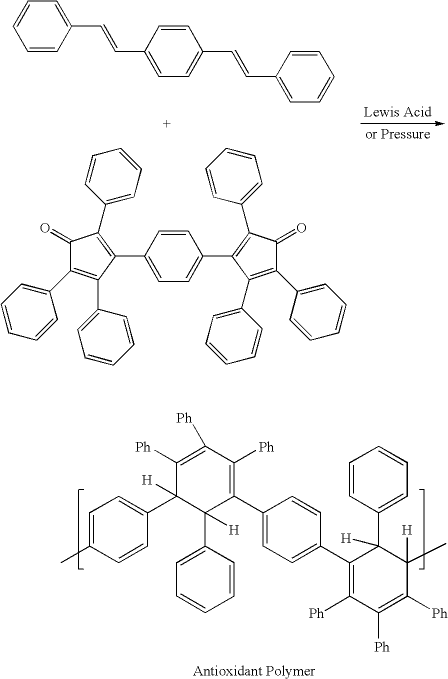

It is important to note that the sulfonic acid or imidazole groups used in the new polymer electrolyte compositions are not a prerequisite for the antioxidant activity, but do not hinder it in any way. Thus, polymeric antioxidants based on the Diels-Alder polymerizations can be prepared without the characteristic ion conducting polyelectrolyte.

As antioxidant materials, phenolic or phosphite, thiol or amine additives-suffer due to limited solubility in polymers. Phenolic or phosphite, thiol or amine additives may compromise polymer properties due to plasticization. Because those materials can be leached out of the polymers, there are also health and safety concerns.

The benefits of the antioxidant polymers of this invention include, but are not limited to: (1) by virtue of their 4 equivalents of hydrogen per repeat unit, they have high antioxidant capacities built into the polymer to provide longer polymer lifetimes without adversely affecting the polymer through plasticization or phase separation. That high capacity even makes these materials effective for oxygen barriers; (2) as part of the polymer, the antioxidant will not leach out into the environment; (3) the product of the antioxidant is a stable, completely aromatic polymer; (4) the antioxidant polymers of this invention are oxidatively resistant materials useful for electrochemical cells, fuel cells, electrolysis cells, oxygen barrier materials, sealants and adhesives for photovoltaics, OLED's; (5) many of the bis-diene and a bis-dienophile monomers in this invention are synthesized by shorter, potentially less expensive procedures than the monomers used in earlier Diels-Alder polymerizations.

The method used to prepare the polymers of the present invention may utilize high temperatures, Lewis acid catalysts, microwaves and/or pressure to control the regiochemistry of the Diels-Alder reaction in such a way as to allow systematic control over the polymer void volume and permeability to gases.

Further, the method used to prepare the polymers of the present invention permits the formation of incompletely aromatized rings in the polymer backbone that can act as reducing agents (anti-oxidants) for oxidants.

Yet another aspect of the present invention is a pre-functionalized polyarylene polymer with reduced segmental mobility of the polymer chains.

Still another aspect of the present invention provides for a method of making polymer compositions having 2 to 6 pendant sulfonic acid groups regularly positioned per each monomer repeat unit. The ultimate ion exchange capacity for the pre-functionalized polyarylene ranges form about 0.5 (SO₃/H) of the polymer to about 5.0 meq (SO₃H)/g of the polymer.

Another aspect of the present invention provides for a polymer electrolyte membrane with improved proton conductance over that of Nafion® 117 membranes.

Another aspect of the present invention provides for a polymer electrolyte membrane with improved proton conductance over that of Nafion® 117 membranes at temperatures in the range of about 90° C. to over 130° C. Yet another aspect of the present invention provides for a polymer electrolyte membrane that has better mechanical properties than Nafion® 117 membranes at temperatures in the range of about 90° C. to over 130° C.

Another aspect of the present invention provides for a polymer electrolyte membrane with an improved ion exchange capacity over that of Nafion® 117 membranes. Another aspect of the present invention provides for a polymer electrolyte membrane with a higher temperature of glass transition (T_{g}) over that of Nafion® 117. Still another aspect of the present invention provides for polymer compositions (A, B, or C, below) comprising a repeat unit selected from a group consisting of:

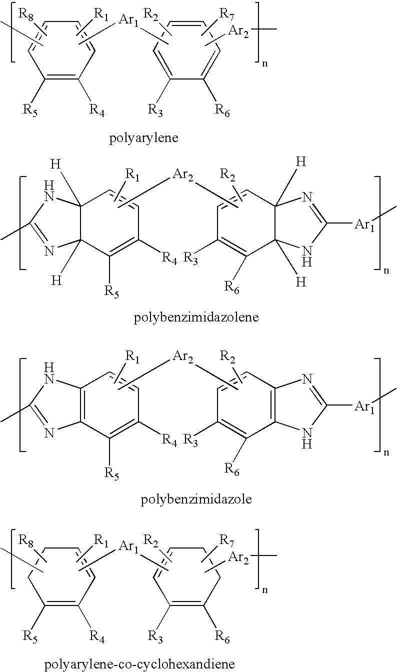

The repeat unit of the polymer of the present invention contains Ar₁ and Ar₂ moeities in the polymer backbone that link the polymer together, for example, by connecting the phenylene or cyclohexadienyl rings of arylene, benzimidazolene, benzinidazole and arylene-co-cyclohexandiene-based monomers. These groups are synthesized as part of each diene and dienophile respectively, linking the two dienes or dienophiles together. Ar₁ represents an un-substituted or inertly substituted aromatic moiety in the polymer backbone; Ar₂ represents an un-substituted or inertly substituted aromatic moiety in the polymer backbone. Aromatic moieties (Ar₁ and Ar₂) include 1,4-phenylene, 1,3-phenylene, 4,4′-biphenylene, 3,3′-biphenylene, 3,4′-biphenylene, 4,4″-terphenylene, 9,10-anthracene, 1,5-naphthalene, 1,4-naphthalene, 2,6-naphthalene, 2,7-naphthalene, 1,4-tetrafluorophenylene, 1,3-tetrafluorophenylene. Substituent groups attached to the polymer backbone are denoted as R₁, R₂, R₃, R₄, R₅, R₆, R₇, and R₈ which are the same or different, wherein each R₁-R₈ is H or an unsubstituted or inertly-substituted aromatic moiety, an aromatic moiety substituted with one or more sulfonic acid groups or sulfur containing functional groups (thiol ethers, thiol acetates, disulfides, phenols, ethers or trialkylsilyl groups) that is subsequently convertible to sulfonic acid groups. Pendant moieties, R₁, R₂, R₃, R₄, R₅, R₆, R₇, and R₈, include any combination of hydrogen, phenyl, biphenyl, terphenyl, naphthyl, sulfonic acid substituted phenyl, biphenyl, terphenyl or naphthyl groups, alkylthiolaryl (R₉—S—Ar—, where R₉=any alkyl group from C₁-C₁₈, such as methyl, ethyl, isopropyl, t-butyl at any position on the aryl group and Ar is a phenyl, biphenyl, terphenyl, naphthyl), bisalkylthiolaryl ([R₉S]₂Ar—, where two thio ether groups with R₉=any alkyl group from C₁-C₁₈ are attached to each aryl group and each Ar is a phenyl, biphenyl, terphenyl, naphthyl), trisalkylthiolaryl ([R₉S]₂Ar—, where three thio ether groups with R₉=any alkyl group from C₁-C₁₈ are attached to each aryl group and each Ar is a phenyl, biphenyl, terphenyl, naphthyl), thioacetylaryls,(R₉C═OSAr or R₉C═SOAr, where 1-3 thioacetyl groups are attached to the pendant aryl where R₉ is any alkyl group from C₁-C₁₈ and Ar is is a phenyl, biphenyl, terphenyl, naphthyl), aryldisulfides (R₉SSAr, where 1-3 disulfides are attached to each pendant aryl where R₉ is any alkyl group or perfluorinated alkyl group from C₁-C₁₈ and each Ar is a phenyl, biphenyl, terphenyl, naphthyl), alkoxyaryl (R₉OAr, where 1-3 alkoxyaryl groups are attached to each pendant aryl where R is a hydrogen or any alkyl group from C₁-C₁₈ and Ar is is a phenyl, biphenyl, terphenyl, naphthyl), and 2-, 3-, or 4-trialkylsilyl- or 3,4-, 2,3-, 2,5-, 3,5-bis(trialkylsilyl) substituted phenyl, biphenyl, terphenyl or naphthyl.

According to one embodiment of the present invention, the number of repeat units (n) range from 2-50. According to another embodiment the number of repeat units (n) ranges from 50-200. According to yet another embodiment, the number of repeat units (n) range from 200-1000. According to yet another embodiment, the number of repeat units (n) are above 1000.

Yet another embodiment of the present invention relates to a membrane electrode assembly comprising an anode; a cathode; and a polymer electrolyte membrane positioned between the anode and cathode wherein at least one of the anode, cathode and polymer electrolyte membrane comprises a sulfonated polyarylene polymer composition.

### BRIEF DESCRIPTION OF THE DRAWINGS

FIG. 1 is a table illustrating the test results of conductivity measurements of the present invention.

### DETAILED DESCRIPTION OF THE COMPOSITIONS OF THE INVENTION

Although described herein with respect to preferred embodiments, the present invention is not meant to be so limited, and other modifications and embodiments that fall within the scope of the present invention as herein described will be readily apparent to those of skill in the art who read the present application. The descriptions are illustrative only and should not be viewed as limiting.

The Diels-Alder polymerization approach of the present invention is extremely versatile. Both diene and dienophile monomers can be tailored with different substituents (pendant groups, R₁-R₈) and bridging groups (Ar₁ and Ar₂). The syntheses of these monomers is relatively easy in comparison to some of the more expensive monomers used to make competing polyelectrolytes (see C above) such as polybenzimidazole. This prior art polymer is prepared by condensing tetraminobiphenyl with a biscarboxyaromatic co-monomer. The former has been reported to cost $4444 per kilogram. In addition to varying the bridging and pendant groups, the method of this invention makes it possible to vary the nature of the dienophile and diene functionalities themselves. One of the principle target diene monomers is a bis-thiophene dioxide.

The present invention employs two distinct strategies to modify monomers to directly afford sulfonated polyarylenes. One is to synthesize monomers with sulfonic acid groups in the desired location. The second is to synthesize monomers with latent sulfonic acid groups. Those latent sulfonic acid groups (thiol ethers, thiol esters, disulfides, etc) would be converted into the sulfonic acid groups after the polymer has been synthesized. In both circumstances, the number and distribution of the sulfonic acid groups on and along the macromolecules can be strictly controlled. This strategy also opens up the possibility of preparing block polymers in which one segment is sulfonated to act as the hydrophilic ion conductor and the second segment is left un-sulfonated and hydrophobic to anchor the polymer against dissolving away and to control the morphology in the membrane. Which approach is taken depends on which monomer is being modified. For example, in the Diels-Alder reaction of bis-cyclone (bis-diene) with bis-acetylene (bis-dienophile), sulfonic acid groups (electron withdrawing) on the former will enhance the polymerization while sulfonic acid groups on the latter will retard the polymerization. On the other hand, thiol ethers, thiol esters, and disulfides will have the opposite effect, enhancing the polymerization when placed on the dienophile and retarding the polymerization when placed on the diene.

The thiol ethers and esters will be oxidized to sulfonic acid groups after the polymer has been prepared. Sulfonic acids can be introduced into the polymer as thioethers, RSAr with R being any alkyl substituent, thioesters, RC═OS—Ar or RC═SO—Ar, or disulfides, RSSAr where R is any alkyl or persulfonated alkyl, and subsequently converted to sulfonic acid groups by deprotecting and oxidation after being formed into a membrane or as trialkylsilylsubstituted aryl groups by site-specific sulfonation in solution or after the membrane is formed. Furthermore, the protecting group strategy can be used to permit photolithographic patterning of thin films. The sulfonic acid groups are not as acidic as those in Nafion® 117, but that doesn't have a significant effect on the proton conductivity.

The morphology of the parent polyarylene provides for up to six (6) sulfonic acid moieties to attach to carbons of the aromatic moieties attached to the polyarylene backbone of the repeat units (for example when the aromatic moieties are phenyl groups).

The number of repeat units in a polymer ranges from 2 or more where n preferably ranges from about 130 to about 300.

Polyarylene polymers and sulfonated polyarylene polymers provide for improved thermal stability, while maintaining organic solubility making it possible to form films with improved mechanical properties when compared to Nafion® 117 films from Dupont. According to another embodiment of the present invention, a composition comprising polyarylene repeat units is polymerized to form polyarylene polymers of between about 30-50,000 repeat units. The polyarylene is synthesized by two sequential pericyclic reactions: a Diels Alder cycloaddition to link the diene covalently with the dienophile monomers and a chelatropic elimination to form the desired aromatic or cyclohexadienyl ring as part of the polymer backbone. One example is where 1,4-bis-(tetraphenylcyclopetadienone)benzene reacts with 1,4--bis(ethynyl)benzene to yield polyarylene. Additional examples include the reaction of 3,6-diphenyltetrazine with 1,4-bis(ethynyl)benzene to afford a polyarylene, the reaction of a bisthiophene dioxide diene with a 1,4--bis(ethynyl)benzene to afford a polyarylene, and the reaction of a 1,4-bis-(tetraphenylcyclopetadienone)benzene or bistetrazine with 1,4-bis-imidazolebenzene to afford a polybenzimidazolene or, after oxidation, a polybenzimidazole.

The repeat unit contains Ar₁ and Ar₂ moeities in the polymer backbone that link the polymer together. These groups are synthesized as part of each diene and dienophile, respectively, linking the two dienes or dienophiles together. Ar₁ represents an un-substituted or inertly substituted aromatic moiety in the polymer backbone; Ar₂ represents an un-substituted or inertly substituted aromatic moiety in the polymer backbone. Aromatic moieties (Ar₁ and Ar₂) includes 1,4-phenylene, 1,3-phenylene, 4,4′-biphenylene, 3,3′-biphenylene, 3,4′-biphenylene, 4,4″-terphenylene, 9,10-anthracene, 1,5-naphthalene, 1,4-naphthalene, 2,6-naphthalene, 2,7-naphthalene, 1,4-tetrafluorophenylene, 1,3-tetrafluorophenylene. Substituent groups on attached to the polymer backbone are described as R₁, R₂, R₃, R₄, R₅, R₆, R₇, and R₈ which are the same or different, wherein each R₁-R₈ is H or an unsubstituted or inertly-substituted aromatic moiety, an aromatic moiety substituted with one or more sulfonic acid groups or sulfur containing functional groups (thiol ethers, thiol acetates, disulfides, phenols or ethers) that is subsequently convertible to sulfonic acid groups. Pendant moieties, R₁, R₂, R₃, R₄, R₅, R₆, R₇, and R₈, include any combination of hydrogen, phenyl, biphenyl, terphenyl, naphthyl, sulfonic acid substituted phenyl, biphenyl, terphenyl or naphthyl groups, alkylthiolaryl (R₉—S—Ar—, where R₉=any alkyl group from C₁-C₁₈, such as methyl, ethyl, isopropyl, t-butyl at any position on the aryl group and Ar is a phenyl, biphenyl, terphenyl, naphthyl), bisalkylthiolaryl ([R₉S]₂Ar—, where two thio ether groups with R₉=any alkyl group from C₁-C₁₈ are attached to each aryl group and each Ar is a phenyl, biphenyl, terphenyl, naphthyl), trisalkylthiolaryl ([R₉S]₂Ar—, where three thio ether groups with R₉=any alkyl group from C₁-C₁₈ are attached to each aryl group and each Ar is a phenyl, biphenyl, terphenyl, naphthyl), thioacetylaryls,(R₉C═OSAr or R₉C═SOAr, where 1-3 thioacetyl groups are attached to the pendant aryl where R₉ is any alkyl group from C₁-C₁₈ and Ar is is a phenyl, biphenyl, terphenyl, naphthyl), aryldisulfides (R₉SSAr, where 1-3 disulfides are attached to each pendant aryl where R₉ is any alkyl group or perfluorinated alkyl group from C₁-C₁₈ and each Ar is a phenyl, biphenyl, terphenyl, naphthyl), alkoxyaryl (R₉OAr, where 1-3 alkoxyaryl groups are attached to each pendant aryl where R is a hydrogen or any alkyl group from C₁-C₁₈ and Ar is is a phenyl, biphenyl, terphenyl, naphthyl) and and 2-, 3-, or 4-trialkylsilyl- or 3,4-, 2,3-, 2,5-, 3,5-bis(trialkylsilyl) substituted phenyl, biphenyl, terphenyl or naphthyl.

The following examples provided are intended for illustrative purposes and do not limit the scope of the invention, since other suitable sulfonating agents will be apparent to one of ordinary skill in the art.

### EXAMPLE I

Electrochemical Impedance Spectroscopy (EIS) was used to collect proton conductivity data for polyarylene polymer materials and sulfonated polyarylene polymer material. Films are measured by four probe EIS using a Solartron 1260 frequency analyzer and a Solartron 1287 potentiostat and a test cell designed to measure the materials impedance by the point method. The resistance of each film was measured while totally submerged in deionized-water during each measurement at 25° C. Proton conductivity was calculated using Eq. 1

ρ=d/(A·R) Equation 1

where d is the electrode distance (0.5 cm), A is the cross sectional area of the film, and R is the film resistance. The conductivities are determined in hydrated films by AC impedance spectroscopy over a frequency range of 1×10³ Hz to 1×10⁶ Hz.

The sulfonated polyarylene of the present invention are also useful as battery separators, electrolytes for electrosynthesis cells, electrolytes for electrolysis cells, electrolytes for gas generating electrochemical systems, as ionic membranes in electrochemical sensors, as electrolytes in electrochemical scrubbers and other purification systems and as electrolytes in primary and secondary batteries. Polyarylene electrolytes were prepared from new pre-functionalized monomers that were first polymerized by a thermal Diels-Alder reaction, and then chemically converted into the desired sulfonic acid functionalized form.

The new monomer was directly prepared from 1-bromo-4-(tert-butylsulfanyl)benzene and 1,4-diethynylbenzene using a palladium catalyzed coupling reaction (Greg Fu et al. Org. Lett. 2000, 2, 1729). This compound has recently been reported by Stuhr-Hansen, N.; Sorensen, J. K.; Moth-Poulsen, K.; Christensen, J. B.; Bjornholm, T.; Nielsen, M. B., “Synthetic protocols and building blocks for molecular electronics,” Tetrahedron 2005, 61, 12288. In this procedure, however, the monomer was prepared in three steps from 1-bromo-4-(tert-butylsulfanyl)benzene by first making the 1-trimethylsilyethynyl-4-(tert-butylsulfanyl)benzene, hydrolyzing the silyl protection and coupling the product thereof with 1,4-diiodobenzene to afford the product. Our procedure for preparing the monomer is given below:
1,4-bis[[4-[(1,1-dimethylethyl)thio]phenyl]ethynyl]benzene

In a flame dried 250 mL, 3-neck, round-bottom flask fitted with Fredrick's condenser and maintained under dynamic flow of argon, bis(benzonitrile)palladium chloride (0.4648 g, 1.200 mmol) and copper (I) iodide (0.088 g, 0.8 mmol) were dissolved in 32 mL of 1:1 (v/v) degassed mixture of tetrahydrofuran and toluene. The mixture was stirred at room temperature for 10 min to allow the content to dissolve. Then diisopropylamine (6.8 mL, 48 mmol) followed by 10% solution of P(t-Bu₃) in hexane (5.04 mL, 24 mmol) were added followed by aryl bromide (10 g, 40 mmol) and diethynylbenzene (2.572 g, 20 mmol). The reaction mixture was heated at 50° C. for 2 hours followed by overnight stirring at room temperature. The crude product was dissolved in toluene and poured into 1000 ml separatory funnel and washed with 3×100 ml brine solution. A brown turbid suspension was obtained with some yellow precipitate at the bottom. The solution was passed through silica gel bed and washed with toluene. The trapped solid was then collected separately by dissolving in dichloromethane and passing through silica gel. The contents were separately evaporated to obtain 8.5 g of dark brown toluene soluble part and 4.5 g of dichloromethane soluble part.

Carbon black was added to the dichloromethane solution (1:1 wt %) and filtered though whatman#1 filter on top of glass microfibre filter papers in Büchner funnel under vacuum to give white, shiny crystals (3.32 g, 18.5%). Melting Point: 206-209° C. ( Lit.: 205-207° C.); ¹H NMR (250 MHz, CDCl₃): 1.28 (s, ˜18H), 7.48 (m, 12H). ¹³C NMR (62 MHz, CDCl₃): 31, 47, 90 (?), 123.5, 124, 132, 134, 137.5; Mass Spec (LDI): MH⁺ m/z: 455.2857 (MH⁺ calculated for C₃₀H₃₀S₂ 455.1789).

The monomer was then copolymerized (1:1) with bis-tetracyclone (3,3′-(1,4-phenylene)bis[2,4,5-triphenyl-2,4-cyclopentadien-1-one] at 220° C. in diphenyl ether over twelve days to give the desired polyarylene with two t-butyl thiol ether groups per repeat unit as latent sulfonic acid groups. The procedure for preparing the polymer is given below:
Poly(2,5,6,2″,5″,6″-hexaphenyl-3,3″-bis(4-[(1,1-dimethylethyl)thio]phenyl)-quaterphenyl-4,4′″-diyl)

In a flame-dried, 250 mL, 3-neck, round-bottom flask fitted with Fredrick's condenser and maintained under dynamic flow of argon, bistetracyclone (3.45 g, 5.00 mmol) and 1,4-bis((4-(tert-butylthio)phenyl)ethynyl)benzene (2.27 g, 5.00 mmol) were dissolved in 50 mL diphenyl ether. The reaction mixture was then set to reflux for 12 days. The polymer was precipitated by pouring, dropwise, into hexanes; wherein a mud-brown precipitate was obtained. The polymer was then redissolved in dichloromethane and re-precipitated in hexanes, filtered and dried in an oven. This process was repeated twice to obtain a light brown powder of the polymer (2.16 g, 39.7%). Molecular weight (dynamic light scattering, dn/dc=0.3 mL/g))=91K Da. ¹H NMR (300 MHz, CDCl₃): 1.04-1.25 (m, ˜18H), ˜6.7 (m, ˜34H).

Conversion to the sulfonic acid functionalized polyarylene required loss of the t-butyl groups and oxidation of the sulfur. It is shown that treatment of a solution of the polymer in dichloromethane effectively accomplished both reactions in a single step. The procedure is set forth below:
Poly(2,5,6,2″,5″,6″-hexaphenyl-3,3″-bis(4-sulfophenyl)-quaterphenyl-4,4′″-diyl)

In a 50 mL round-bottom flask fitted with condenser, 50 mg (0.090 mmol) poly-bistetracyclone-co-1,4-bis[[4-[(1,1-dimethylethyl)thio]phenyl]ethynyl]benzene was dissolved in 3 mL dichloromethane and 0.03 mL (5 equivalents) concentrated nitric acid was then added. The color of the solution changed from dark blackish-brown to light brown and eventually the product precipitated out. Evolution of gas was observed. The gas was not characterized but may be isobutylene from the deprotection of the thioether groups. The product was washed with water (5×10 mL) and dried overnight in oven under vacuum. ¹H NMR (300 MHz, CDCl₃): 2.16 ppm (SO₃H), 3.0 ppm (SH), ˜7 ppm (aromatic-H).

### Preparation of Membranes for Conductivity Testing

Processing of the polymeric membranes: the Aluminum leveler plate was placed in the hood and leveled perfectly flat with the help of the screws. Then the glass mould was placed on the Aluminum plate and the mould was also leveled. About 45 mL of polymer solution (5 wt %) was poured into the mould carefully, and it was lightly heated from the top with the help of a flood lamp. After about 40 hrs the solvent evaporated from the mould, and the mould was placed in liquid water to release the membrane. A flat membrane was obtained which had uniform thickness of 102 microns, and the approximate weight of the membrane was 0.450 g.

### Conductivity Measurements

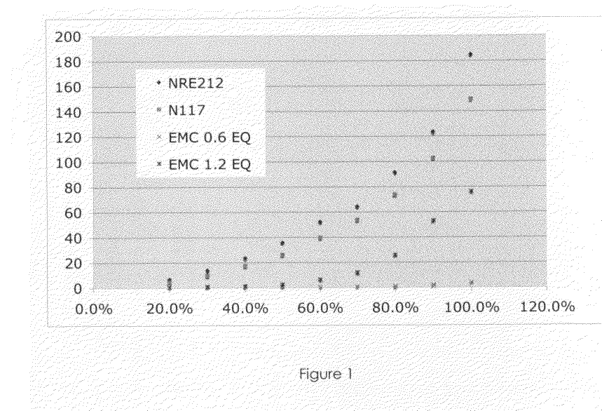

Proton conductivity of the polymer electrolyte membranes (PEM) was measured by the DC 4 Probe Bekktech Proton Conductivity Meter at 80° C. from 20% to 100% RH. PEM sample size tested—Approximately 4 mm (width) by 25 mm (length). Thickness of the membrane can be varied. A PEM sample having the necessary dimensions is then assembled into the BekkTech Conductivity Cell, and the Conductivity Cell is then assembled into the Bekktech Membrane Conductivity Test System. The sample is conditioned at 70% RH for 2 hours at the desired temperature of test like 60° C. or 80° C. or 120° C. and the testing is performed with a nitrogen flow rate of 500-1000 SCCM. Only for the test done at 120° C. a back pressure of 250 kPa is applied to the Conductivity Cell to maintain the required amount of humidity in the Conductivity Cell. After conditioning the sample, test operating conditions are so adjusted so as to allow about 15 minutes of stabilization at each conditions of humidity (20% to 100%) at the desired operating temperature. A DC Linear Sweep is performed continuously throughout the test. Voltage sweeps are carried from 0.1 V to −0.1 V and then the Voltage-Current data is fit for resistance. The test results are illustrated in FIG. 1.

It will be apparent to those skilled in the art that other types of equipment that record the necessary images may be employed and related statistical and analysis techniques may be used without departing from the scope of the invention as claimed. Further, the embodiments described herein are illustrative only and are not meant as limitations on the claims hereof.

What is claimed is:

1. A polyarylene polymer comprising repeat units selected from a group consisting of the following chemical formulas: 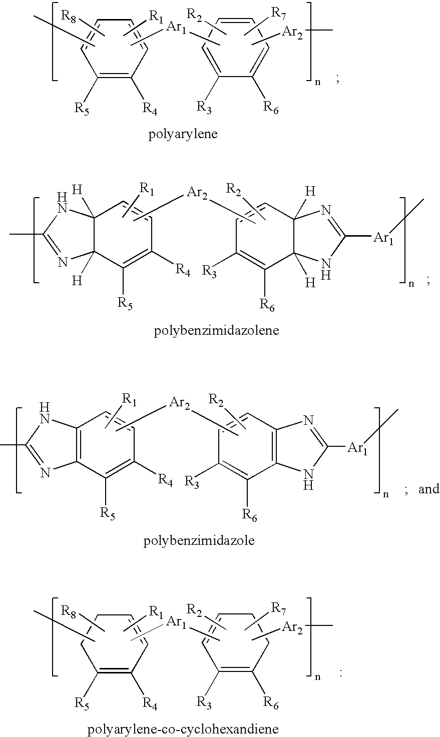
wherein Ar₁ and Ar₂ are Arene groups capable of connecting the repeat units, and each Arene group is an un-substituted or an inertly substituted aromatic moiety, wherein the repeat units comprise at least two phenylene or cyclohexadienyl rings, each phenylene or cyclohexadienyl ring comprising substituent pendant groups R₁, R₂, R₃, R₄, R₅, R₆, R₇, and R₈, each substituent pendant group is selected from the group consisting of hydrogen, an unsubstituted aromatic moiety, an inertly-substituted aromatic moiety, and an aromatic moiety substituted with one or more functional groups comprising sulfonic acid groups or functional groups that are subsequently convertible to sulfonic acid groups selected from the group consisting of thiol ethers, thiol acetates, disulfides, phenols and ethers; and wherein n ranges from 2 to 50,000.

2. The polyarylene polymer of claim 1 wherein each Arene group is selected from the group consisting of 1,4-phenylene, 1,3-phenylene, 4,4′-biphenylene, 3,3′-biphenylene, 3,4′-biphenylene, 4,4′-terphenylene, 1,4-tetrafluorophenylene and 1,3-tetrafluorophenylene.

3. The polyarylene polymer of claim 1 wherein each substituent pendant group,is selected from the group consisting of hydrogen, phenyl, sulfonic acid substituted phenyl groups, alkylthiolaryl (R₉—S—Ar—, where R₉=methyl, ethyl, isopropyl or t-butyl at any position on the aryl group and Ar is a phenyl), bisalkylthiolaryl ([R₉S]₂Ar—, where two thio ether groups with R₉=methyl, ethyl, isopropyl or t-butyl are attached to each aryl group and each Ar is a phenyl), trisalkylthiolaryl ([R₉S]₂Ar—, where three thio ether groups with R₉=methyl, ethyl, isopropyl or t-butyl are attached to each aryl group and each Ar is a phenyl), thioacetylaryl,(R₉C═OSAr or R₉C═SOAr, where 1-3 thioacetyl groups are attached to the pendant aryl where R₉=methyl, ethyl, isopropyl or t-butyl and Ar is a phenyl), aryldisulfides (R₉SSAr, where 1-3 disulfides are attached to each pendant aryl where R₉=methyl, ethyl, isopropyl or t-butyl, perflouoromethyl, ethyl, propyl, butyl, pentyl, hexyl, heptyl, octyl, nonyl or decyl, and each Ar is a phenyl), and Me3SiAr (2-, 3-, or 4-trialkylsilyl- or 3,4-, 2,3-, 2,5-, 3,5-bis(trialkylsilyl) substituted phenyl).

4. The polyarylene polymer of claim 1, wherein the sulfonated polyarylenes are prepared from the Diels-Alder co-polymerization of bis-alkynylarene dienophiles with a diene comonomer selected from the group consisting of bis(cyclopentadienone)arene, 3,6-tetrazine, and bis(thiophenedioxide)arene, as set forth in the following chemical reaction:

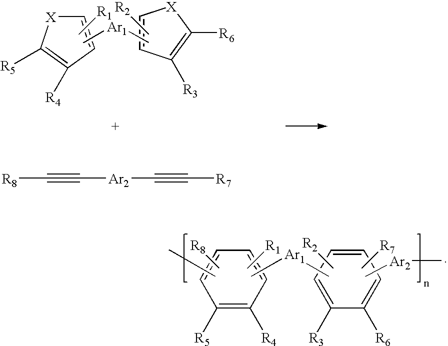

5. The polyarylene polymer of claim 1, wherein the polymer comprises a proton conductivity at 25° C. of about 1 mS/cm to above 125 mS/cm.

6. The polyarylene polymer of claim 1 wherein the sulfonic acid groups are distributed in the polymer based on their disposition in the dienophile and/or diene monomers.

7. The polyarylene polymer of claim 1, wherein aryl functionality is varied through the selection of monomers in the polymerizations to control solubility in aqueous solutions and in organic solutions.

8. The polyarylene polymer of claim 1, wherein sulfonic acid groups in the polyarylene may be present in the monomers.

9. The polyarylene polymer of claim 1, wherein sulfonic acid groups are formed by the chemical conversion of a latent sulfonic acid group from a functional group selected from the group consisting of thiol ether, ester and disulfide, after the polyarylene has been prepared.

10. A polyarylene polymer comprising benzimidazolene and benzimidazole polyarylene electrolytes which comprise repeat units selected from the group consisting of the following chemical formulas: 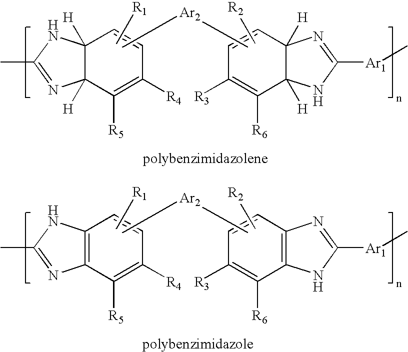
wherein Ar₁ and Ar₂ are Arene groups capable of connecting the repeat units, and each Arene group is an un-substituted or an inertly substituted aromatic moiety, and the repeat units comprise at least two benzimidazolene or benzimidazole rings, each benzimidazolene and benzimidazole ring comprising substituent pendant groups R₁, R₂, R₃, R₄, R₅, R₆, R₇, and R₈, each substituent pendant group being selected from the group consisting of hydrogen, an unsubstituted aromatic moiety, an inertly-substituted aromatic moiety and an aromatic moiety substituted with one or more functional groups comprising sulfonic acid groups or functional groups that are subsequently convertible to sulfonic acid groups selected from the group consisting of thiol ethers, thiol acetates, disulfides, phenols and ethers; and wherein n ranges from 2 to 50,000.

11. The polyarylene polymer of claim 10 wherein each Arene group is selected from the group consisting of 1,4-phenylene, 1,3-phenylene, 4,4′-biphenylene, 3,3′-biphenylene, 3,4′-biphenylene, 4,4′-terphenylene, 1,4-tetrafluorophenylene, and 1,3-tetrafluorophenylene.

12. The polyarylene polymer of claim 10 wherein each substituent pendant group is selected from the group consisting of hydrogen, phenyl, sulfonic acid substituted phenyl groups, alkylthiolaryl (R₉—S—Ar—, where R₉=methyl, ethyl, isopropyl or t-butyl at any position on the aryl group and Ar is a phenyl), bisalkylthiolaryl ([R₉S]₂Ar—, where two thio ether groups with R₉=methyl, ethyl, isopropyl or t-butyl are attached to each aryl group and each Ar is a phenyl), trisalkylthiolaryl ([R₉S]₂Ar—, where three thio ether groups with R₉=methyl, ethyl, isopropyl or t-butyl are attached to each aryl group and each Ar is a phenyl), thioacetylaryl,(R₉C═OSAr or R₉C═SOAr, where 1-3 thioacetyl groups are attached to the pendant aryl where R₉=methyl, ethyl, isopropyl or t-butyl and Ar is a phenyl), aryldisulfides (R₉SSAr, where 1-3 disulfides are attached to each pendant aryl where R₉=methyl, ethyl, isopropyl or t-butyl, perflouoromethyl, ethyl, propyl, butyl, pentyl, hexyl, heptyl, octyl, nonyl or decyl, and each Ar is a phenyl), and Me3SiAr (2-, 3-, or 4-trialkylsilyl- or 3,4-, 2,3-, 2,5-, 3,5-bis(trialkylsilyl) substituted phenyl).

13. The polyarylene polymer of claim 10, wherein the benzimizolene and benzimidazole polyarylenes are prepared via the Diels-Alder co-polymerization of bis-imidazole-arene dienophiles with a diene comonomer selected from the group consisting of bis(cyclopentadienone)arene, 3,6-tetrazine, and bis(thiophenedioxide)arene.

14. The polyarylene polymer of claim 10, wherein the benzimizolene and benzimidazole polyarylenes are functionalized with sulfonic acid groups from zero to six per repeat unit to provide acidic doping conducive to proton conductivity.

15. The polyarylene polymer of claim 10 wherein n ranges from about 130-50,000.

16. The polyarylene polymer of claim 10, wherein the benzimidazolene polyarylene has four hydrogens in two cyclohexadiene groups in the polymer backbone that can act as antioxidants and radical inhibitors.

17. Polyarylene polymers bearing cyclohexadiene groups in a polymer backbone comprising a repeat unit of the following chemical formula: 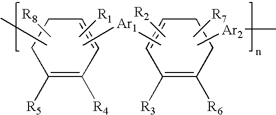
wherein Ar₁ and Ar₂ are Arene groups capable of connecting the repeat units, and two Arene groups connect cyclohexadiene groups, and each Arene group is an un-substituted or an inertly substituted aromatic moiety; wherein the repeat units comprise at least two cyclohexadiene groups; wherein each cyclohexadiene group comprises substituent pendant groups, R₁, R₂, R₃, R₄, R₅, R₆, R₇, and R₈, each substituent pendant group comprising H or an unsubstituted or an inertly-substituted aromatic moiety, an aromatic moiety substituted with one or more functional groups comprising sulfonic acid groups or functional groups that are subsequently convertible to sulfonic acid groups selected from the group consisting of thiol ethers, thiol acetates, disulfides, phenols and ethers; and wherein n ranges from 2 to 50,000.

18. The polyarylene polymer of claim 17 wherein each substituent pendant group is selected from the group consisting of hydrogen, phenyl, sulfonic acid substituted phenyl groups, alkylthiolaryl (R₉—S—Ar—, where R₉=methyl, ethyl, isopropyl or t-butyl at any position on the aryl group and Ar is a phenyl), bisalkylthiolaryl ([R₉S]₂Ar—, where two thio ether groups with R₉=methyl, ethyl, isopropyl or t-butyl are attached to each aryl group and each Ar is a phenyl), trisalkylthiolaryl ([R₉S]₂Ar—, where three thio ether groups with R₉=methyl, ethyl, isopropyl or t-butyl are attached to each aryl group and each Ar is a phenyl), thioacetylaryl,(R₉C═OSAr or R₉C═SOAr, where 1-3 thioacetyl groups are attached to the pendant aryl where R₉=methyl, ethyl, isopropyl or t-butyl and Ar is a phenyl), aryldisulfides (R₉SSAr, where 1-3 disulfides are attached to each pendant aryl where R₉=methyl, ethyl, isopropyl or t-butyl, perflouoromethyl, ethyl, propyl, butyl, pentyl, hexyl, heptyl, octyl, nonyl or decyl, and each Ar is a phenyl), and Me3SiAr (2-, 3-, or 4-trialkylsilyl- or 3,4-, 2,3-, 2,5-, 3,5-bis(trialkylsilyl) substituted phenyl).

19. The polyarylene polymer of claim 17, wherein the polyarylenes have four hydrogens in two cyclohexadiene groups in the polymer backbone that can act as antioxidants and radical inhibitors, the loss of the hydrogens converting the polyarylene into the fully aromatic polyarylene.
